(19) United States
(12) Patent Application Publication
(10) Pub. No.: US 2005/0176403 A1
(43) Pub. Date: Aug. 11, 2005

(54) System and method for providing an emergency response via a wireless system

(76) Inventor: Dimitrios Lalos, St. Charles, IL (US)

Correspondence Address: LEE, MANN, SMITH, MCWILLIAMS, SWEENEY & OHLSON, P.O. BOX 2786, CHICAGO, IL, 60690, US

(21) Appl. No.: 11/036,444

(22) Filed: Jan. 14, 2005

Related U.S. Application Data
(60) Provisional application No. 60/536,578, filed on Jan. 15, 2004.

(51) Int. Cl. H04M 11/04

(52) U.S. Cl. 455/404.1; 455/521; 455/456.1

(57) ABSTRACT

The system and method for providing an emergency response via a wireless system disclosed herein. The system includes a mobile transceiver assembly having an emergency notification device and a location determination device, and an operations center operatively coupled to the mobile transceiver assembly via the radio frequency link. The method includes receiving a location of the mobile transceiver assembly, detecting actuation of an emergency notification device of the mobile transceiver assembly, causing an emergency notification signal to be transmitted to the facility controller, causing an identity and the location of the mobile transceiver assembly to be transmitted to the facility controller; and enabling an emergency response action to be initiated by an operations center attendant located at the operations center.

### CROSS-REFERENCE TO RELATED APPLICATIONS

This application claims benefit under 35 U.S.C. section 119(e) from co-pending U.S. Provisional Patent Application No. 60/536,578, filed Jan. 15, 2004, naming Dimitrios Lalos as inventor, and titled “REMOTE CONTROL MOBILE STATION FOR AUTOMATICALLY PROVIDING POSITION LOCATION AND AUDIO ASSISTANCE FOR EMERGENCY COMMUNCIATIONS”.

### BACKGROUND OF THE INVENTION

This invention disclosure relates to a system and method for responding to an emergency, and more particularly to a system and method for providing an emergency response via a wireless system.

Mobile transceiver assemblies utilizing one of any number of radio frequency links are well known in the art. Mobile transceiver assemblies typically transmit and receive via a radio network that may include a number of fixed base stations with antennas, one or more mobile switching center(s), PSTNs and satellites. The radio network may also include one or more links to the Internet, to a local area network (LAN) and/or to a wide area network (WAN). Although communicating via one or more fixed base stations, a typical mobile transceiver assembly caller or emergency personnel do not know the exact location of the mobile transceiver assembly.

In some cases however, the mobile transceiver assembly may include location determination capability. Such a capability is typically enabled via the use of a global positioning system (GPS) receiver in the mobile transceiver assembly where the GPS receiver is in communication with a GPS satellite. Other well known methods of determining a location of a mobile transceiver station include trilateration, or triangulation, utilizing a time of arrival (TOA) algorithm and at least one fixed base station receiver (or WiFi hot spot) and/or smart antenna technology.

Mobile transceiver assemblies having position-finding capability may be configured to gain access to a variety of services, including, for example, emergency roadside assistance (ERA) service, personal emergency response (PER) service, vehicle tracking assistance (VTA) service, traveler information assistance (TIA) service, traffic incident management (TIM), and fleet management, to name a few.

In some applications such as VTA service, automatically transmitting mobile transceiver assembly location information to a responder is sufficient to adequately address an emergency situation and dispatch help (e.g., dispatching a tow truck to assist a car stalled on the roadside). Unfortunately, in other emergency situations, transmitting only mobile transceiver assembly location information to the responder is not enough to enable an adequate response to the emergency situation.

### SUMMARY OF THE INVENTION

The system and method for providing an emergency response via a wireless system disclosed herein improves on the prior art in a number of ways. In addition to dispatching emergency responders to the proper geographic location, it generally enables transmission of audio, audible, or text information, in real time, to a distressed registered user of the mobile transceiver assembly (“the registered user”). Moreover, it enables quick access to medical and other personal information/data specific to the registered user, and using that information, allows emergency responders to respond more efficiently. It also allows emergency responders or others having the registered user's information to communicate with the registered user via the mobile transceiver assembly. Further, it enables persons proximate to the registered user to be alerted that an emergency situation is occurring and that the registered user may be in distress. Accordingly, the system and method for providing an emergency response via a wireless system enables help and instruction to be dispatched to the registered user quickly and effectively.

According to a first aspect of the invention, there is disclosed a system for providing an emergency response via a wireless system comprising: a mobile transceiver assembly that includes a radio network transceiver configured to receive and transmit radio frequency signals via a radio frequency link, a location determination receiver configured to receive location determination signals from a location determination transmitter, an emergency notification device configured to generate an emergency notification signal upon actuation by a registered user of the mobile transceiver assembly, and a mobile transceiver assembly controller operatively coupled to the radio network transceiver, the location determination receiver, and the emergency notification device; and an operations center operatively coupled to the mobile transceiver assembly via the radio frequency link where the operations center includes a database processing facility having a data storage device and a facility controller where the data storage device stores personal data associated with the registered user of the mobile transceiver assembly and where the facility controller is adapted to retrieve the personal data of the registered user in response to receipt of the emergency signal, an integrated phone-computer terminal operatively coupled to the facility controller, where the integrated phone-computer terminal is adapted to enable an operations center attendant to initiate an emergency response action in response to receipt of the emergency notification signal, and a communication interface operatively coupled to the data processing facility and the integrated phone-computer terminal where the communication interface is adapted to enable communication between the integrated phone-computer terminal and the mobile transceiver assembly and emergency responders.

Preferably, the mobile transceiver assembly further includes a keypad, a speaker, a microphone, a display, a siren device, and a battery, and the location determination receiver includes a Global Positioning Satellite receiver.

Conveniently, the emergency notification signal includes an identity and a geographic location of the mobile transceiver assembly, and the personal data includes the registered user's identity and medical data. The emergency response action includes dispatching emergency responders, initiating establishment of a full duplex voice channel between the operations center attendant and the registered user, and/or activating an audible alarm of the mobile transceiver assembly.

According to a second aspect of the invention, there is disclosed a method for providing an emergency response via a wireless system where the wireless system includes a mobile transceiver assembly operatively coupled to an operations center via a radio frequency link and where the mobile transceiver assembly includes a mobile transceiver assembly controller, the method comprising: receiving a location of the mobile transceiver assembly via a location determination receiver of the mobile transceiver assembly; detecting actuation of an emergency notification device of the mobile transceiver assembly; causing an emergency notification signal to be transmitted to the operations center in response to the actuation; in response to a data poll, causing an identity and the location of the mobile transceiver assembly to be transmitted to the operations center; and enabling a full duplex communication link to be established between the mobile transceiver assembly and an integrated phone-computer terminal of the operations center in response to an emergency response action initiated by an operations center attendant located at the integrated phone-computer terminal where the full duplex communication link allows communication between a registered user of the mobile transceiver assembly and the operations center attendant.

Conveniently, the step of enabling a full duplex communication link to be established between the mobile transceiver assembly and the integrated phone-computer terminal of the operations center in response to an emergency response action includes enabling an audible alarm to be generated via a speaker of the mobile transceiver assembly; enabling instruction from the operations center attendant to be displayed to the registered user via a display device of the mobile transceiver assembly and enabling audible instructions to be broadcast to the registered user.

Preferably, the step of causing the emergency notification signal to be transmitted to the operations center includes causing a radio network transceiver of the mobile transceiver assembly to transmit the emergency notification signal, and the step of receiving the location of the mobile transceiver assembly includes receiving the location via a Global Positioning Satellite receiver operatively coupled to the mobile transceiver assembly controller.

According to a third aspect of the invention, there is disclosed a method for providing an emergency response via a wireless system, the wireless system including a mobile transceiver assembly operatively coupled to an operations center via a radio frequency link where the mobile transceiver assembly includes a mobile transceiver assembly controller and the operations center includes a facility controller, the method comprising: receiving an emergency notification signal from the mobile transceiver assembly; transmitting a data poll to the mobile transceiver assembly requesting an identity and a location of the mobile transceiver assembly; receiving the identity and the location of the mobile transceiver assembly; based on the identity of the mobile transceiver assembly, retrieving identity and medical data associated with a registered user of the mobile transceiver assembly; and causing the identity and medical data and the location to be transmitted to an integrated phone-computer terminal of the operations center.

Preferably, the method further comprises establishing a full duplex communication link between the mobile transceiver assembly and the integrated phone-computer terminal, causing an audible alarm to be generated via a speaker of the mobile transceiver assembly, causing instruction from an operations center attendant to be displayed to the registered user via a display device of the mobile transceiver assembly, and transmitting the location of the mobile transceiver assembly and the identity and medical data of the registered user to emergency responders, all in response to an emergency response action initiated by the operations center attendant located at the integrated phone-computer terminal where the full duplex communication link allows communication between the registered user of the mobile transceiver assembly and the operations center attendant.

Advantageously, the step of retrieving identity and medical data associated with the registered user includes retrieving identity and medical data from a data storage device coupled to the facility controller, and the step of receiving the identity and the location of the mobile transceiver assembly includes receiving the identity and the location from a radio network receiver of the mobile transceiver assembly where the location of the mobile transceiver assembly is detected by a Global Positioning Satellite receiver or Time-of-Arrival estimating device operatively coupled to the mobile transceiver assembly controller.

Other objects, advantages and novel features of the present disclosure will become apparent from the following detailed description when considered in conjunction with the accompanying drawings.

### BRIEF DESCRIPTION OF THE DRAWINGS

FIG. 1 is a functional block diagram of a wireless system for providing an emergency response according to an embodiment of the invention;

FIG. 2 is a functional block diagram of an exemplary mobile transceiver assembly of FIG. 1;

FIG. 3 is a flowchart of an emergency response routing that may be performed utilizing elements of the wireless system of FIG. 1; and

FIG. 4 is a further functional diagram of the system according to the invention.

### DETAILED DESCRIPTION

Throughout the description, identical reference numbers are used to identify like parts.

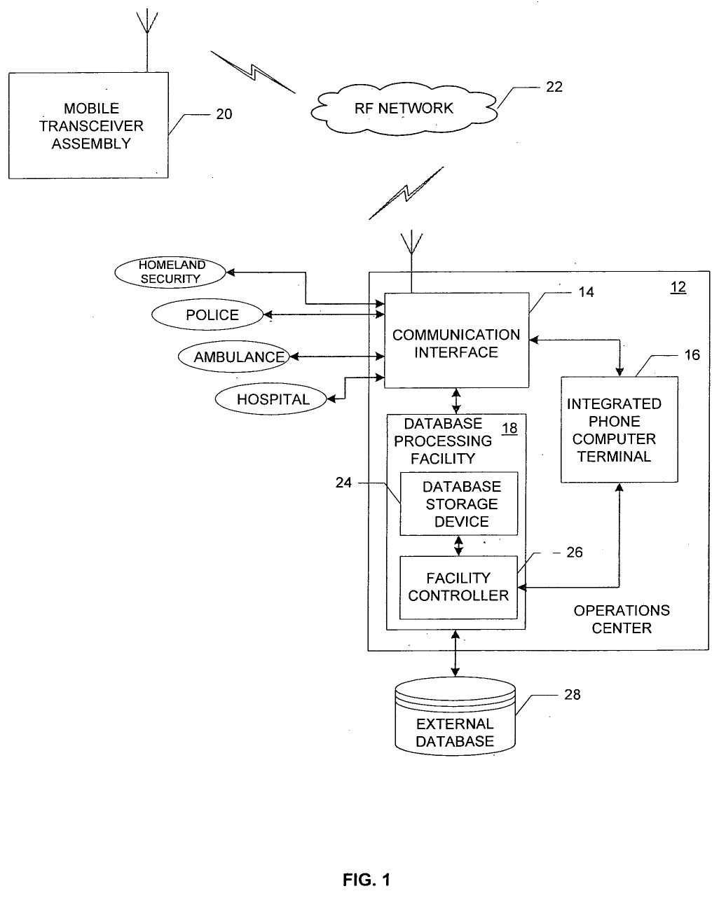

FIG. 1 is a functional block diagram of an exemplary wireless system 10 for providing an emergency response according to an embodiment of the invention. The wireless system 10 includes an operations center 12 having a communications interface 14, one or more integrated phone-computer terminals 16 and a database processing facility 18 operatively coupled to both the communication interface 14 and the integrated phone-computer terminal 16. The integrated phone-computer terminal 16 is also operatively coupled to the communication interface 14.

The integrated phone-computer terminal 16 provides both telephone and computer functionality. Accordingly, the integrated phone-computer terminal 16 may have one of any number of configurations including, for example, a smart-phone with a suitable display, or a telephone coupled to a computer having a display. In cases where more than one integrated phone-computer terminal 16 is utilized, the integrated phone-computer terminals 16 may be arranged in a network using one of many well known methods (e.g., using an Ethernet LAN arrangement).

As illustrated by FIG. 1, the communication interface 14 is configured to enable wireless or wired transmission/receipt to and from emergency personnel such as police, ambulance and hospital personnel. In some cases, the communication interface 14 may be configured to enable wireless or wired transmission/receipt to and from the Department of Homeland Security. The communication interface 14 is also configured to enable wireless transmission/receipt to and from mobile transceiver assemblies, such as a mobile transceiver assembly 20 via a radio frequency (RF) network 22. Thus, an operations center attendant located at the integrated phone-computer terminal 16 may communicate with emergency personal or a registered user(s) of the mobile transceiver assembly(s) 20 via the communications interface 14 and/or the RF network 22.

The RF network 22 may support one of any number of types of mobile transceiver assemblies 20 utilizing one of a number of radio frequency protocols. For example, the RF network 22 may support a mobile phone utilizing a code division multiple access (CDMA) protocol or a Global System for Mobile Communications (GSM) protocol, etc., or it may support a personal digital assistant (PDA) or laptop computer utilizing one of any number of 802.1x protocols such as, for example, enhanced Bluetooth, WiFi and WiMax. The RF network 22 may further include satellite links. Moreover, as will be appreciated by those skilled in the art, the RF network 22 may include Internet capability to support Institute of Electrical and Electronic Engineers (IEEE) standards such as IEEE 802.XX.

The database processing facility 18 includes a data storage device 24 and a facility controller 26 operatively coupled to the data storage device 24. The data storage device 24 is configured to store personal data associated with one or more registered users of the mobile transceiver assembly(s) 20. The personal data may include, for example, the identity of the registered user, medical data associated with the registered user, medical personnel preferences of the registered user, drug allergies, next of kin data, etc. An external database 28 coupled to the database processing facility 18 may also be provided to store additional personal data associated with registered users.

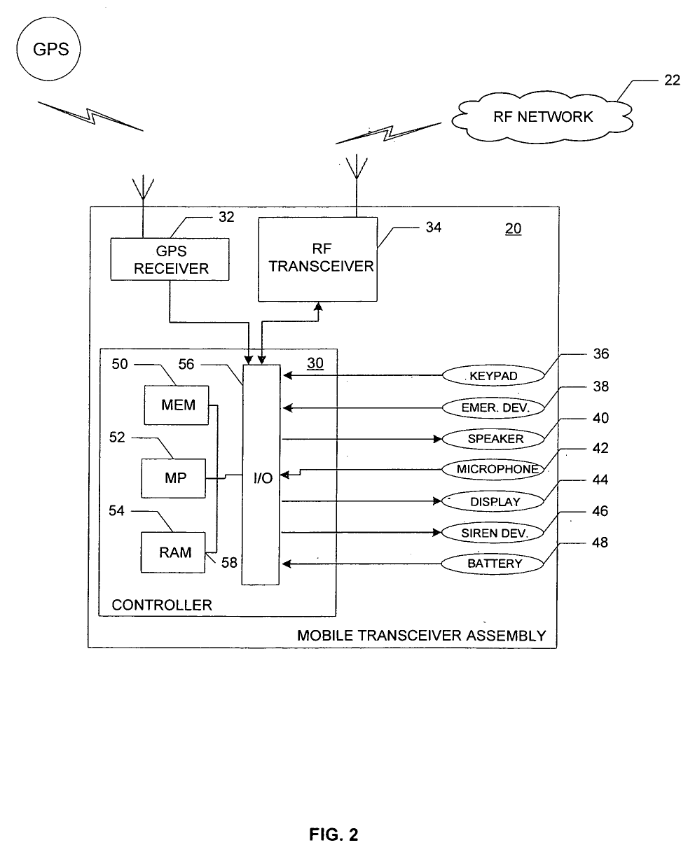

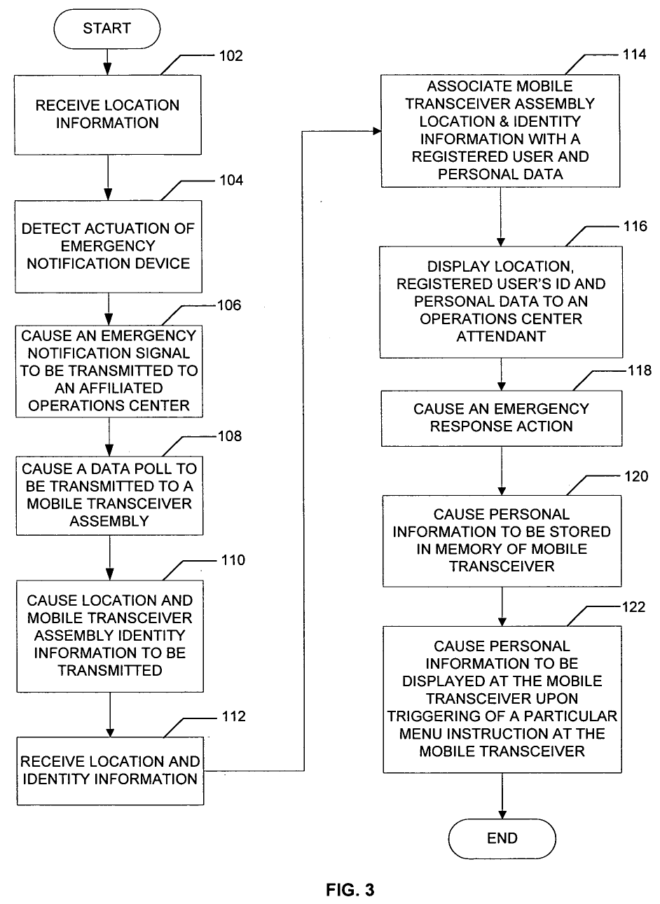

Although not separately shown in detail, the facility controller 26 includes at least a processor and a memory operatively coupled to the processor of the facility controller 26. (See, FIG. 2). The facility controller 26 is adapted to control various operations of the operations center 12 and is discussed below in connection with a flowchart (see, FIG. 3) that represents a number of portions or routines of one or more computer programs.

FIG. 2 is a more detailed functional block diagram of the mobile transceiver assembly 20 of the wireless system of FIG. 1. As mentioned in connection with FIG. 1, the mobile transceiver assembly 20 may be one of any number of mobile transceiver assemblies utilizing one of a number of suitable radio frequency protocols.

Referring to FIG. 2, the mobile transceiver assembly 20 includes a mobile transceiver assembly controller 30 coupled to a location determination receiver 32 (e.g., a GPS receiver) and an RF transceiver 34. The RF transceiver 34 is configured to receive and transmit radio frequency signals via radio frequency links of the RF network 22. The mobile transceiver assembly 20 may also include a keypad 36, an emergency notification device 38, a speaker 40, a microphone 42, a display 44, a siren device 46 and a battery 48, all coupled to the mobile transceiver assembly controller 30.

During operation, the emergency notification device 38 is adapted to generate an emergency notification signal upon its actuation by the registered user of the mobile transceiver assembly 20. Accordingly, the emergency notification device 38 may be any one of a button, a voice activated device or a biometric activated device, to name a few. Among other things, the keypad 36 is adapted to enable the registered user to textually communicate with an operations center attendant located at the operations center 12; the speaker 40 is adapted to transmit audible instructions from an operations center attendant to the register user and, in some cases, to transmit an audible alarm (via the siren device 46) to persons proximate to the mobile transceiver assembly 20; the microphone 42 is adapted to enable the registered user to audibly communicated with the operations center attendant; and the display 44 is adapted to display instruction from the operations center attendant to the registered user.

The mobile transceiver assembly controller 30 may include a program memory 50 (including a read only memory (ROM)), a microcontroller-based platform or microprocessor (MP) 52, a random-access memory (RAM) 54 and an input/output (I/O) circuit 56, all of which may be interconnected via a communications link, or an address/data bus 58.

The microprocessor 52 is capable of, among other things, detecting actuation of the emergency notification device 38, causing an emergency notification signal to be transmitted via the RF transceiver 34 and enabling a communications link to be established by the operations center 12. The RAM 54 is capable of storing data used or generated during an emergency situation, etc. The program memory 50 is capable of storing program code that, among other things, controls operation of the mobile transceiver assembly 20. For example, based on detecting actuation of the emergency notification device 38, the microprocessor 52, executing code in the program memory 50, causes an emergency notification signal to be transmitted via the radio transceiver assembly 34.

Although only one microprocessor 52 is shown, the mobile transceiver assembly controller 30 may include multiple microprocessors. Similarly, additional memory (e.g., flash memory) may be included, depending on the requirements of the mobile transceiver assembly 20. The RAM(s) 54 and program memory(s) 50 may be implemented as semiconductor memories, magnetically readable memories, and/or optically readable memories, etc. Although not separately illustrated in detail, the facility controller 26 is similarly constructed and operable.

One manner in which the wireless system 10 may operate is described below in connection with a flowchart (see, FIG. 3) that represents a number of portions or routines of one or more computer programs, which may be stored in one or more of the memories of the facility controller 26 and/or the mobile transceiver assembly controller 30. The computer program(s) or portions thereof may also be stored remotely, outside of the wireless system 10 and may therefore control the operation from a remote location.

FIG. 3 is a flowchart of an emergency response routine 100 that may be performed by the facility controller 26 and the mobile transceiver assembly controller 30. Referring to FIG. 3, the emergency response routine 100 begins when the mobile transceiver assembly controller 30 detects actuation of the emergency notification device 38 by a registered user of the mobile transceiver assembly 20 (step 104). Such a registered user has previously registered with and provided his/her personal data to the operations center 12 and may additionally have paid a fee.

Upon detecting actuation of the emergency notification device 38, the mobile transceiver assembly controller 30 causes an emergency notification signal to be transmitted via the RF transceiver 34 to the operations center 12 (step 106).

In response to detecting receipt of the emergency notification signal via the communication interface 14, the facility controller 26 causes a data poll or other suitable request or query for information to be transmitted to the mobile transceiver assembly 20 (step 108). The data poll includes a request for the geographic location and identity of the mobile transceiver assembly 20. The geographic location of the mobile transceiver assembly 20 is periodically received via the GSP receiver 32 or a Time-of-Arrival device and temporarily stored via the mobile transceiver assembly controller 30. The mobile transceiver assembly 20 is uniquely identified by a mobile ID number (MIN) correlated with an electronic serial number (ESN) of the mobile transceiver assembly that is also stored via the mobile transceiver assembly controller 30.

Upon receipt of the request from the facility controller 26, the mobile transceiver assembly controller 30 causes the requested location and identity information of the mobile transceiver assembly 20 to be transmitted to the operations center 12 (step 110). Upon receipt of the location and mobile transceiver assembly identity information (step 112), the facility controller 26 associates (i.e., matches) the identity information of the mobile transceiver assembly 20 to the particular registered user and that registered user's personal data (step 114). Similarly, the facility controller 26 associates the location of the mobile transceiver assembly 20 to nearby landmarks, intersections, road services and to the applicable 911 jurisdiction. Once associated, the mobile transceiver assembly identity and location information, the registered user's identity, and personal data may be forwarded to the integrated phone-computer terminal 16 and an operations center attendant.

Alternatively, the facility controller 26 may cause the identity and location information of the mobile transceiver assembly 20 to be transmitted directly to the integrated phone-computer terminal 16. An operations center attendant may then, using personal data records displayed via the integrated phone-computer terminal 16, associate the mobile transceiver assembly identity information to the particular registered user and that registered user's personal data. As previously mentioned, the personal data may include medical history and issues, medical preferences, drug allergies, special instructions, next of kin, etc. Once associated, all of the data including the mobile transceiver assembly identity and location information, the registered user's identity and personal data may be displayed via the integrated phone-computer terminal 16 (step 116).

Next, an emergency response action is initiated by the operations center attendant (step 118). It is contemplated however, that the facility controller 26 may also initiate the emergency response action. The emergency response action may include one or more types of emergency responses depending on a number of factors including, inter alia, the medical condition of the registered user, his/her location and environment, and the time of day.

As part of the emergency response action in step 118, personal information stored at the Network Center may be made available to emergency personnel 60 arriving at the scene. To this end, personal information concerning the registered user can be stored in the memory of the mobile transceiver in step 120. Then, that personal information may be displayed at the mobile transceiver upon triggering of a particular menu instruction at the mobile transceiver, in step 122.

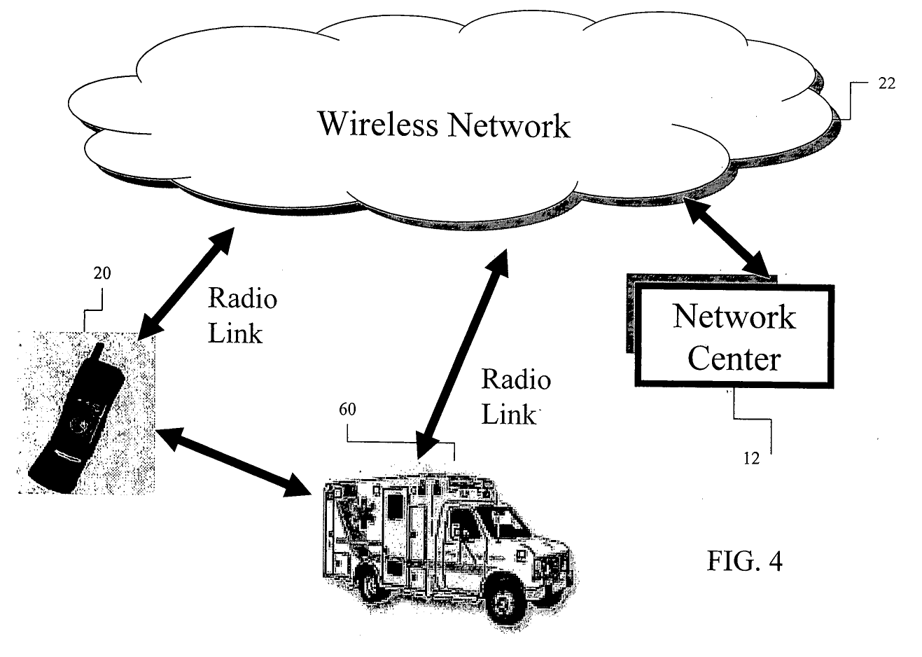

FIG. 4 illustrates the basic components of the invention, in combination with emergency personnel 60. The mobile transceiver assembly 20 of the distress user communicate with the Network Center 12, and may also communicate via the emergency personnel 60 to the Network Center 12. In this manner, data exchange can be via the mobile transceiver assembly 20 and/or a computer system of the emergency personnel 60, and verification of the distress user can be directly via the emergency personnel 60 by fingerprint identification or otherwise.

For example, a full duplex communication link may be established between the mobile transceiver assembly 20 and the integrated phone-computer terminal 16 to allow communication between the distressed registered user and the operations center attendant. An audible alarm may also be generated at the mobile transceiver assembly 20 to alert people proximate to the mobile transceiver assembly 20 that the registered user is in distress. Instructions from the operations center attendant may be displayed to the registered user via the display device 44 of the mobile transceiver assembly 20, or may be audibly broadcast to the registered user via the speaker 40. Emergency personnel 60 may also be dispatched to the location of the distressed registered user. Further, the identity and personal data of the registered user may be transmitted to the emergency personnel, via wireless or landline means to assist them in helping the registered user.

When emergency personnel 60 are deployed, the Network Center 12 coordinates activity and is issued the response personnel's identification. The Network Center forwards medical information of the person under distress to the computer of the emergency personnel, such as an onboard vehicle computer. The emergency personnel check and verify personal data of the person under distress by causing the mobile transceiver assembly 20 to display personal information, or causing the mobile transceiver 20, via a wireless link such as blue tooth, WiFi, etc, to transmit the personal information to the computer of the emergency personnel 60, or the person under distress is fingerprinted, causing release of the personal information.

As may be apparent from the above discussion, the system and method for providing an emergency response via a wireless system disclosed herein enables a distressed registered user of a mobile transceiver assembly to easily summon “informed” rescue personnel to their geographic location. In addition to dispatching emergency responders to the proper geographic location, the system and method for providing an emergency response via a wireless system generally enables transmission of audio, audible, or text information, in real time, to the distressed registered user. Further, it enables quick access to medical and other personal information/data specific to the registered user, and using that information, allows the emergency responders to respond more efficiently. Further, it enables persons proximate to the distressed registered user to be alerted that an emergency situation is occurring. Accordingly, the system and method for providing an emergency response via a wireless system enables help and instruction to be dispatched to the registered user quickly and effectively.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the invention are desired to be protected. The applicant has provided description and figures which are intended as illustrations of embodiments of the disclosure, and are not intended to be construed as containing or implying limitation of the disclosure to those embodiments.

1. A system for providing an emergency response via a radio frequency link, the system comprising:
a) a mobile transceiver assembly including:
a radio network transceiver configured to receive and transmit radio frequency signals via a the radio frequency link,
a location determination receiver configured to receive location determination signals from a location determination transmitter,
an emergency notification device configured to generate an emergency notification signal upon actuation by a registered user of the mobile transceiver assembly, the emergency notification signal configured to be transmitted via the radio network transceiver, and
a mobile transceiver assembly controller operatively coupled to the radio network transceiver, the location determination receiver, and the emergency notification device, the mobile transceiver assembly controller including a processor and a memory operatively coupled to the processor of the mobile transceiver assembly controller; and
b) an operations center operatively coupled to the mobile transceiver assembly via the radio frequency link, the operation center including:
a database processing facility including a data storage device and a facility controller operatively coupled to the data storage device, the data storage device storing personal data associated with the registered user of the mobile transceiver assembly, the facility controller including a processor and a memory operatively coupled to the processor of the facility controller, the facility controller adapted to retrieve the personal data of the registered user in response to receipt of the emergency signal,
an integrated phone-computer terminal operatively coupled to the facility controller, the integrated phone-computer terminal adapted to enable an operations center attendant to initiate an emergency response action in response to receipt of the emergency notification signal, and
a communication interface operatively coupled to the data processing facility and the integrated phone-computer terminal, the communication interface adapted to enable communication between the integrated phone-computer terminal and the mobile transceiver assembly and emergency responders.

2. The system of claim 1, further comprising an external database operatively coupled to the facility controller, the external database configured to store personal data associated with a plurality of registered users.

3. The system of claim 1, wherein the mobile transceiver assembly further comprises:
a keypad coupled to the mobile transceiver assembly controller and adapted to enable the registered user to textually communicate with the operations center attendant;
a speaker coupled to the mobile transceiver assembly controller and adapted to transmit audible instructions from the operations center attendant to the register user and to transmit an audible alarm to persons proximate to the mobile transceiver assembly;
a microphone coupled to the mobile transceiver assembly controller and adapted to enable the registered user to audibly communicated with the operations center attendant; and
a display device coupled to the mobile transceiver assembly and adapted to display instruction from the operations center attendant to the registered user.

4. The system of claim 1, wherein the personal data includes registered user identity and medical data.

5. The system of claim 1, including a biometric device for identification of a fingerprint in association with medical records.

6. The system of claim 1, wherein the emergency notification signal includes an identity and a geographic location of the mobile transceiver assembly.

7. The system of claim 1, wherein the emergency response action includes dispatching emergency responders.

8. The system of claim 1, wherein the emergency response action includes establishing of a full duplex voice channel between the operations center attendant and the registered user.

9. The system of claim 1, wherein the emergency response action includes activating the audible alarm.

10. The system of claim 1, wherein the location determination receiver is selected from the group consisting of a Global Positioning Satellite receiver and a Time-of-Arrival estimating device.

11. A method for providing an emergency response via a wireless system, the wireless system including a mobile transceiver assembly operatively coupled to an operations center via a radio frequency link, the mobile transceiver assembly including a mobile transceiver assembly controller, the method comprising:
receiving a geographic location of the mobile transceiver assembly via a location determination receiver of the mobile transceiver assembly;
detecting actuation of an emergency notification device of the mobile transceiver assembly;
causing an emergency notification signal to be transmitted to the operations center in response to the actuation;
in response to a data poll, causing an identity and the geographic location of the mobile transceiver assembly to be transmitted to the operations center; and
enabling a full duplex communication link to be established between the mobile transceiver assembly and an integrated phone-computer terminal of the operations center in response to an emergency response action initiated by an operations center attendant located at the integrated phone-computer terminal, the full duplex communication link allowing communication between a registered user of the mobile transceiver assembly and the operations center attendant.

12. The method of claim 11, further comprising enabling an audible alarm to be generated via a speaker of the mobile transceiver assembly.

13. The method of claim 11, further comprising enabling instruction from the operations center attendant to be displayed to the registered user via a display device of the mobile transceiver assembly.

14. The method of claim 11, wherein causing the emergency notification signal to be transmitted to the operations center includes causing a radio network transceiver of the mobile transceiver assembly to transmit the emergency notification signal.

15. The method of claim 11, wherein receiving the geographic location of the mobile transceiver assembly includes receiving the geographic location via a Global Positioning Satellite receiver operatively coupled to the mobile transceiver assembly controller.

16. The method of claim 11, wherein the mobile transceiver assembly controller includes a processor and a memory operatively coupled to the processor of the mobile transceiver assembly.

17. A method for providing an emergency response via a wireless system, the wireless system including a mobile transceiver assembly operatively coupled to an operations center via a radio frequency link, the mobile transceiver assembly including a mobile transceiver assembly controller, the operations center including a facility controller, the method comprising:
receiving an emergency notification signal from the mobile transceiver assembly;
transmitting a data poll to the mobile transceiver assembly requesting an identity and a location of the mobile transceiver assembly;
receiving the identity and the geographic location of the mobile transceiver assembly;
based on the identity of the mobile transceiver assembly, retrieving identity and medical data associated with a registered user of the mobile transceiver assembly; and
causing the identity and medical data and the geographic location to be transmitted to an integrated phone-computer terminal of the operations center.

18. The method of claim 17, further comprising:
based on the geographic location of the mobile transceiver assembly, retrieving geographic data and 911 jurisdiction data; and
causing the geographic data and 911 jurisdiction data to be transmitted to the integrated phone-computer terminal of the operations center.

19. The method of claim 17, further comprising establishing a full duplex communication link between the mobile transceiver assembly and the integrated phone-computer terminal in response to an emergency response action initiated by an operations center attendant located at the integrated phone-computer terminal, the full duplex communication link allowing communication between the registered user of the mobile transceiver assembly and the operations center attendant.

20. The method of claim 19, further comprising causing an audible alarm to be generated via a speaker of the mobile transceiver assembly.

21. The method of claim 19, further comprising causing instruction from the operations center attendant to be displayed to the registered user via a display device of the mobile transceiver assembly.

22. The method of claim 19, further comprising causing audible instruction to be broadcast to the registered user via a speaker of the mobile transceiver assembly.

23. The method of claim 19, further comprising transmitting the location of the mobile transceiver assembly and the identity and medical data of the registered user to emergency responders.

24. The method of claim 19, wherein retrieving identity and medical data associated with the registered user includes retrieving identity and medical data from a data storage device coupled to the facility controller.

25. The method of claim 17, wherein receiving the identity and the geographic location of the mobile transceiver assembly comprises receiving the identity and the geographic location from a radio network receiver of the mobile transceiver assembly, the geographic location of the mobile transceiver assembly detected by a Global Positioning Satellite receiver operatively coupled to the mobile transceiver assembly controller.
